(19) United States
(12) Patent Application Publication
(10) Pub. No.: US 2011/0248716 A1
(43) Pub. Date: Oct. 13, 2011

(54) CURRENT MEASUREMENT FOR WATER-BASED MUD GALVANIC ELECTRICAL IMAGING AND LATEROLOG TOOLS

(75) Inventor: Martin Folberth, Hannover (DE)

(73) Assignee: BAKER HUGHES INCORPORATED, Houston, TX (US)

(21) Appl. No.: 13/080,242

(22) Filed: Apr. 5, 2011

Related U.S. Application Data
(60) Provisional application No. 61/323,122, filed on Apr. 12, 2010.

(51) Int. Cl. G01V 3/18

(52) U.S. Cl. 324/338

(57) ABSTRACT

An apparatus and method for estimating a resistivity property of an earth formation involving electric current injected into a wall of a borehole. The apparatus includes a first electrode, a second electrode, and a differential amplifier. The first electrode may be configured to impart an electric current into a borehole wall and be directly connected to a first input of the differential amplifier. The second electrode may be directly connected to a second input of the differential amplifier. The method may also include a summing circuit connected to the output of the differential amplifier. The method includes estimating a resistivity property using the output of the differential amplifier or the summing circuit.

### CROSS-REFERENCES TO RELATED APPLICATIONS

This application claims priority from U.S. Provisional Patent Application Ser. No. 61/323,122, filed on 12 Apr. 2010.

### FIELD OF THE DISCLOSURE

This disclosure generally relates to exploration for hydrocarbons involving electrical investigations of a borehole penetrating an earth formation. More specifically, this disclosure relates to improved estimates of resistivity properties during borehole investigations.

### BACKGROUND OF THE DISCLOSURE

Electrical earth borehole logging is well known and various devices and various techniques have been described for this purpose. Broadly speaking, there are two categories of devices used in electrical logging devices. In the first category, a transmitter (such as a guard electrode) is uses in conjunction with a diffuse return electrode (such as the tool body). A measured electric current flows in a circuit that connects a voltage source to the transmitter, through the earth formation to the return electrode and back to the voltage source in the tool. A second or center electrode is fully or at least partially surrounded by said guard electrode. Provided both electrodes are kept at the same potential, a current flowing through the center electrode is focused into the earth formation by means of the guard electrode. Generally, the center electrode current is several orders of magnitude smaller than the guard current.

In inductive measuring tools, an antenna within the measuring instrument induces a current flow within the earth formation. The magnitude of the induced current is detected using either the same antenna or a separate receiver antenna. The present disclosure belongs to the first category.

With tools in the first category, it is common to use a current measurement transformer between the center and guard electrodes. Provided the transformer and associated measurement circuit provides a small enough impedance between center and guard at the frequency of operation, the condition that both these electrodes are at virtually the same potential is easily met. Along with this configuration, it is common for signal errors to occur due to coupling capacitance between the primary and secondary windings of the current measurement transformer. Additional errors may occur due to magnetic crosstalk between stray magnetic fields of the guard circuit and the center current measurement transformer. Also, in this configuration the signal-to-noise ratio of the described center current measurement is a function of the center current transformer secondary inductance and the voltage input noise of the connected amplifier. This disclosure addresses the mitigation of these errors.

### SUMMARY OF THE DISCLOSURE

In aspects, the present disclosure is related to methods and apparatuses for estimating resistivity properties during borehole investigations involving electric current injected into a wall of the borehole.

One embodiment according to the present disclosure includes an apparatus for estimating a resistivity property of an earth formation, comprising: a downhole assembly configured to be conveyed in a borehole within the earth formation; a first electrode disposed on the downhole assembly and directly connected to a first input of a first differential amplifier and a voltage source, the first electrode being in contact with a borehole fluid; a second electrode disposed on the downhole assembly and directly connected to a second input to the first differential amplifier, the second electrode being in contact with the borehole fluid and operatively coupled to the earth formation, the output of the first differential amplifier configured to transmit a signal indicative of the resistivity property.

Another embodiment according to the present disclosure includes a method for estimating a resistive property of an earth formation, comprising: estimating the resistive property using an apparatus comprising: a downhole assembly configured to be conveyed in a borehole within the earth formation; a first electrode disposed on the downhole assembly and directly connected to a first input of a first differential amplifier and a voltage source, the first electrode being in contact with a borehole fluid; a second electrode disposed on the downhole assembly and directly connected to a second input to the first differential amplifier, the second electrode being in contact with the borehole fluid and operatively connected to the earth formation, the output of the first differential amplifier configured to transmit a signal indicative of the resistivity property.

Examples of the more important features of the disclosure have been summarized rather broadly in order that the detailed description thereof that follows may be better understood and in order that the contributions they represent to the art may be appreciated.

### BRIEF DESCRIPTION OF THE DRAWINGS

For a detailed understanding of the present disclosure, reference should be made to the following detailed description of the embodiments, taken in conjunction with the accompanying drawings, in which like elements have been given like numerals, wherein:

FIG. 1 shows a schematic of an imaging tool deployed in a wellbore along a drill string according to one embodiment of the present disclosure;

FIG. 2 shows a schematic close up of an imaging tool deployed in a wellbore according to one embodiment of the present disclosure;

FIG. 3 shows an equivalent circuit diagram of a current measurement circuit used in a resistivity property estimating tool according to the present disclosure;

FIG. 4 shows an equivalent circuit diagram of a current measurement circuit used in a resistivity property estimating tool for an embodiment including a summing circuit according to the present disclosure;

FIG. 5 shows a flow chart of a method for estimating a resistivity property using an imaging tool according to one embodiment of the present disclosure; and

FIG. 6 graphically illustrates the results of a resistivity sweep using a resistivity property estimating tool according to one embodiment of the present disclosure.

### DETAILED DESCRIPTION

This disclosure generally relates to exploration for hydrocarbons involving electrical investigations of a borehole penetrating an earth formation. More specifically, this disclosure relates to improved imaging during borehole investigations involving electric current injected into a wall of the borehole.

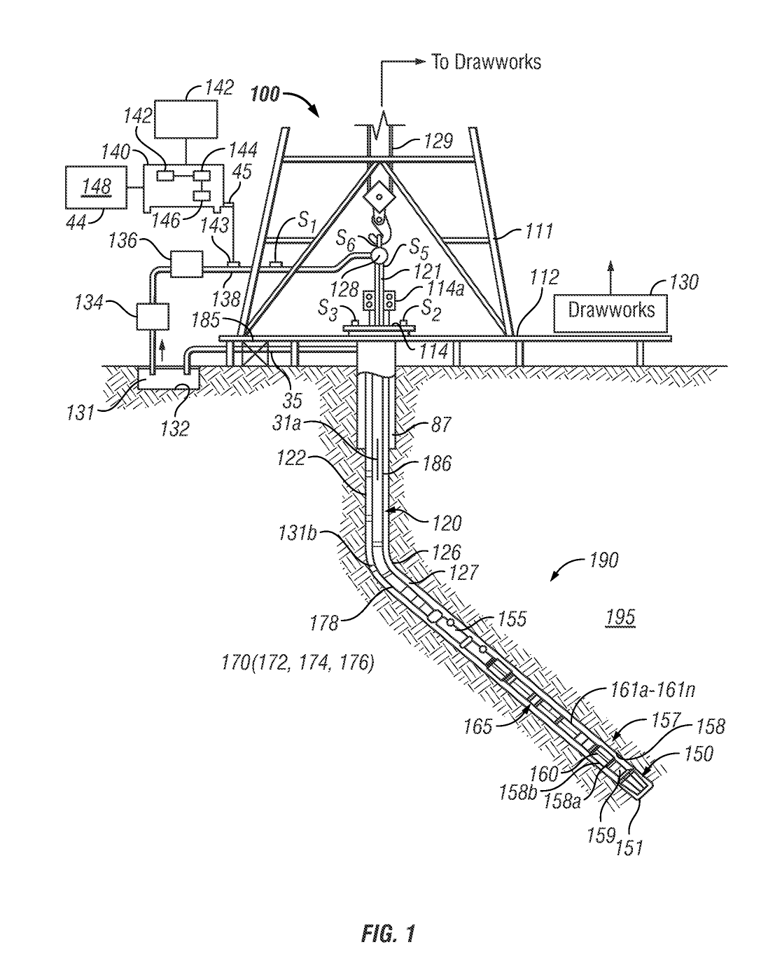

FIG. 1 is a schematic diagram of an exemplary drilling system 100 that includes a drill string having a drilling assembly attached to its bottom end that includes a steering unit according to one embodiment of the disclosure. FIG. 1 shows a drill string 120 that includes a drilling assembly or bottomhole assembly (BHA) 190 conveyed in a borehole 126. The drilling system 100 includes a conventional derrick 111 erected on a platform or floor 112 which supports a rotary table 114 that is rotated by a prime mover, such as an electric motor (not shown), at a desired rotational speed. A tubing (such as jointed drill pipe) 122, having the drilling assembly 190, attached at its bottom end extends from the surface to the bottom 151 of the borehole 126. A drill bit 150, attached to drilling assembly 190, disintegrates the geological formations when it is rotated to drill the borehole 26. The drill string 120 is coupled to a drawworks 130 via a Kelly joint 121, swivel 128 and line 129 through a pulley. Drawworks 130 is operated to control the weight on bit (“WOB”). The drill string 120 may be rotated by a top drive (not shown) instead of by the prime mover and the rotary table 114. Alternatively, a coiled-tubing may be used as the tubing 122. A tubing injector 114a may be used to convey the coiled-tubing having the drilling assembly attached to its bottom end. The operations of the drawworks 130 and the tubing injector 114a are known in the art and are thus not described in detail herein.

A suitable drilling fluid 131 (also referred to as the “mud”) from a source 132 thereof, such as a mud pit, is circulated under pressure through the drill string 120 by a mud pump 134. The drilling fluid 131 passes from the mud pump 134 into the drill string 120 via a desurger 136 and the fluid line 138. The drilling fluid 131a from the drilling tubular discharges at the borehole bottom 151 through openings in the drill bit 150. The returning drilling fluid 131b circulates uphole through the annular space 127 between the drill string 120 and the borehole 126 and returns to the mud pit 132 via a return line 135 and drill cutting screen 185 that removes the drill cuttings 186 from the returning drilling fluid 131b. A sensor S₁ in line 138 provides information about the fluid flow rate. A surface torque sensor S₂ and a sensor S₃ associated with the drill string 120 respectively provide information about the torque and the rotational speed of the drill string 120. Tubing injection speed is determined from the sensor S₅, while the sensor S₆ provides the hook load of the drill string 120.

In some applications, the drill bit 150 is rotated by only rotating the drill pipe 122. However, in many other applications, a downhole motor 155 (mud motor) disposed in the drilling assembly 190 also rotates the drill bit 150. The rate of penetration for a given BHA largely depends on the WOB or the thrust force on the drill bit 150 and its rotational speed.

The mud motor 155 is coupled to the drill bit 150 via a drive shaft disposed in a bearing assembly 157. The mud motor 155 rotates the drill bit 150 when the drilling fluid 131 passes through the mud motor 155 under pressure. The bearing assembly 157, in one aspect, supports the radial and axial forces of the drill bit 150, the down-thrust of the mud motor 155 and the reactive upward loading from the applied weight-on-bit.

A surface control unit or controller 140 receives signals from the downhole sensors and devices via a sensor 143 placed in the fluid line 138 and signals from sensors S₁-S₆ and other sensors used in the system 100 and processes such signals according to programmed instructions provided to the surface control unit 140. The surface control unit 140 displays desired drilling parameters and other information on a display/monitor 142 that is utilized by an operator to control the drilling operations. The surface control unit 140 may be a computer-based unit that may include a processor 142 (such as a microprocessor), a storage device 144, such as a solid-state memory, tape or hard disc, and one or more computer programs 146 in the storage device 144 that are accessible to the processor 142 for executing instructions contained in such programs. The surface control unit 140 may further communicate with a remote control unit 148. The surface control unit 140 may process data relating to the drilling operations, data from the sensors and devices on the surface, data received from downhole, and may control one or more operations of the downhole and surface devices. The data may be transmitted in analog or digital form.

The BHA may also contain formation evaluation sensors or devices (also referred to as measurement-while-drilling (“MWD”) or logging-while-drilling (“LWD”) sensors) determining resistivity, density, porosity, permeability, acoustic properties, nuclear-magnetic resonance properties, formation pressures, properties or characteristics of the fluids downhole and other desired properties of the earth formation 195 surrounding the drilling assembly 190. Such sensors are generally known in the art and for convenience are generally denoted herein by numeral 165. The drilling assembly 190 may further include a variety of other sensors and devices 159 for determining one or more properties of the BHA (such as vibration, bending moment, acceleration, oscillations, whirl, stick-slip, etc.) and drilling operating parameters, such as weight-on-bit, fluid flow rate, pressure, temperature, rate of penetration, azimuth, tool face, drill bit rotation, etc.) For convenience, all such sensors are denoted by numeral 159.

The drilling assembly 190 includes a steering apparatus or tool 158 for steering the drill bit 150 along a desired drilling path. In one aspect, the steering apparatus may include a steering unit 160, having a number of force application members 161a-161n, wherein the steering unit is at partially integrated into the drilling motor. In another embodiment the steering apparatus may include a steering unit 158 having a bent sub and a first steering device 158a to orient the bent sub in the wellbore and the second steering device 158b to maintain the bent sub along a selected drilling direction.

The MWD system may include sensors, circuitry and processing software and algorithms for providing information about desired dynamic drilling parameters relating to the BHA, drill string, the drill bit and downhole equipment such as a drilling motor, steering unit, thrusters, etc. Exemplary sensors include, but are not limited to, drill bit sensors, an RPM sensor, a weight on bit sensor, sensors for measuring mud motor parameters (e.g., mud motor stator temperature, differential pressure across a mud motor, and fluid flow rate through a mud motor), and sensors for measuring acceleration, vibration, whirl, radial displacement, stick-slip, torque, shock, vibration, strain, stress, bending moment, bit bounce, axial thrust, friction, backward rotation, BHA buckling and radial thrust. Sensors distributed along the drill string can measure physical quantities such as drill string acceleration and strain, internal pressures in the drill string bore, external pressure in the annulus, vibration, temperature, electrical and magnetic field intensities inside the drill string, bore of the drill string, etc. Suitable systems for making dynamic downhole measurements include COPILOT, a downhole measurement system, manufactured by BAKER HUGHES INCORPORATED. Suitable systems are also discussed in “Downhole Diagnosis of Drilling Dynamics Data Provides New Level Drilling Process Control to Driller”, SPE 49206, by G. Heisig and J. D. Macpherson, 1998.

The MWD system 100 can include one or more downhole processors at a suitable location such as 193 on the BHA 190. The processor(s) can be a microprocessor that uses a computer program implemented on a suitable machine readable medium that enables the processor to perform the control and processing. The machine readable medium may include ROMs, EPROMs, EAROMs, EEPROMs, Flash Memories, RAMs, Hard Drives and/or Optical disks. Other equipment such as power and data buses, power supplies, and the like will be apparent to one skilled in the art. In one embodiment, the MWD system utilizes mud pulse telemetry to communicate data from a downhole location to the surface while drilling operations take place. The surface processor 142 can process the surface measured data, along with the data transmitted from the downhole processor, to evaluate formation lithology. While a drill string 120 is shown as a conveyance system for sensors 165, it should be understood that embodiments of the present disclosure may be used in connection with tools conveyed via rigid (e.g. jointed tubular or coiled tubing) as well as non-rigid (e.g. wireline, slickline, e-line, etc.) conveyance systems. A downhole assembly (not shown) may include a bottomhole assembly and/or sensors and equipment for implementation of embodiments of the present disclosure on either a drill string or a wireline.

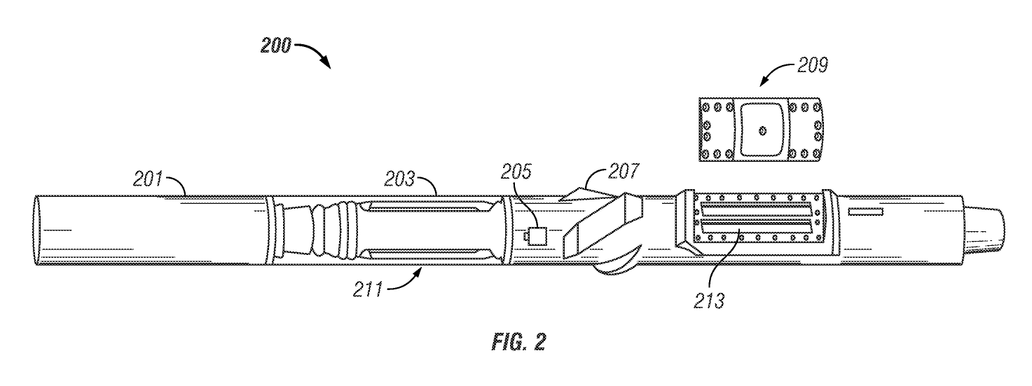

Sensors 165 may include an imaging tool 200, and an exemplary configuration of the various components of imaging tool 200 is shown in FIG. 2. Imaging tool 200 may be in contact with earth formation 195 when performing various measurement operations. The point of contact may be a resistivity array 209 in contact with the earth formation 195. In some embodiments, resistivity array 209 may be configured to be retractable such that, when the resistivity array 209 is not in contact with the earth formation 195, the resistivity array 209 may still be in contact with wellbore drilling fluid 131 that resides within the borehole 126. Tool 200 may be used to generate an image or merely a log of at least one resistivity property.

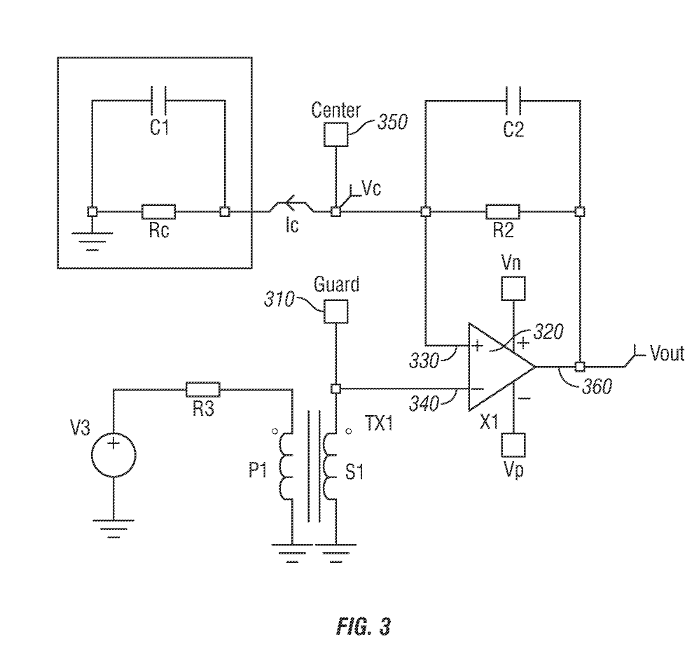

At the upper end, a modular cross-over sub 201 may be provided. The power and processing electronics are indicated by 103. The imaging tool 200 may be provided with a stabilizer 207, and a data dump port may be provided at 205. A resistivity array 209 may be provided with measuring electronics 213. Modular connections 201 are provided at both ends of the imaging tool 200 that enable the tool 200 to be part of the bottom hole drilling assembly. An orientation sensor 211 is provided for measuring the toolface angle of the sensor assembly during continued rotation. Further details regarding resistivity array 209 are shown in FIG. 3.

FIG. 3 shows an equivalent circuit of one embodiment according to the disclosure. FIG. 3 comprises a power source V3 supplying the AC voltage to the guard electrode 310 through its associated output transformer TX1. In some embodiments, power source V3 may be connected to guard electrode 310 without output transformer TX1 being present. Guard 310 is directly connected to a non-inverting input 330 of a differential amplifier 320. Herein, “directly connected” includes a connection with no intervening components or intervention by one or more components that contribute a negligible amount of impedance to the circuit path. As shown, the differential amplifier 320 is pictorially represented by an operational amplifier with a non-inverting input and an inventing input. This representation is illustrative and exemplary only, as embodiments of this disclosure may use any differential amplifier configured to maintain two inputs at an almost identical voltage and with a suitable gain-bandwidth product and gain for the desired application. The secondary winding S1 of transformer TX1 may also ground the non-inverting input 330 with respect to DC voltage. The output voltage vₒᵤₜ taken at the output 360 of amplifier 320 may be fed back to inverting input 340 via resistor R2. In some embodiments, capacitor C2 may be placed in parallel with resistor R2 to provide additional phase margin stability, if required. Resistance and capacitance due to the earth formation 195 may be represented by resistor Rc and capacitor C1, respectively.

Without anything else connected to the inverting input 340, the voltage at terminal 340 will be virtually identical to the voltage at the non-inverting input 330 and guard 310 provided the frequency of operation is sufficiently smaller than the gain-bandwidth product of the differential amplifier 320. Specifying an appropriate gain-bandwidth product for the differential amplifier is known to those of skill in the art and may be a function of the drilling fluid resistivity. In some embodiments, the gain-bandwidth product desired may be selected based on, at least in part, the frequency of operation. In other embodiments, the gain-bandwidth product selection may be further based on, at least in part, one or more of: the center electrode voltage and the guard electrode voltage. When the inverting input 340 is connected to the center electrode 350 and placed in operative contact with the earth formation 195, a current may flow from the center electrode 350 to ground. The same current has to be sourced from the voltage output vₒᵤₜ through the network R2∥C2. Typically, the capacitance of capacitor C2, if present, is negligible at the frequency of normal operations. Then voltage output vₒᵤₜ=i_{C}*R₂+v_{Guard}, provided C2 is negligible. Thus, this circuit provides an effective Center current measurement without the use of a dedicated sensing element, such as measurement transformer, since:

$${i}_{c} = \frac{{v}_{out} - {v}_{Guard}}{{R}_{2}}$$

In some embodiments, where the voltage difference between voltages measured at the guard electrode 310 and the center electrode 350 are small, the Guard voltage v_{Guard} serve as a substitute for the center voltage when calculating the Center admittance Y_{c}, as:

$${Y}_{c} = \frac{{v}_{out} - {v}_{Guard}}{{v}_{Guard} * {R}_{2}}$$

with

$${R}_{c} = \frac{1}{Re ( {Y}_{c} )} .$$

The output voltage vₒᵤₜ may be calculated as follows: vₒᵤₜ=v_{Guard}*(R₂*Y_{C}+1). For large resistivities, the R₂*Y_{C} product may become as small as 0.01, which means the difference between vₒᵤₜ and v_{Guard} may be close to 1%. This in turn calls for a reasonably accurate difference calculation of vₒᵤₜ−v_{Guard}, which, due to the fact that any aliasing filter drifts over temperature and may adversely affect the accuracy, may be done with a precision analog summing circuit employing matched resistors or, alternatively, digitally after analog-to-digital conversion.

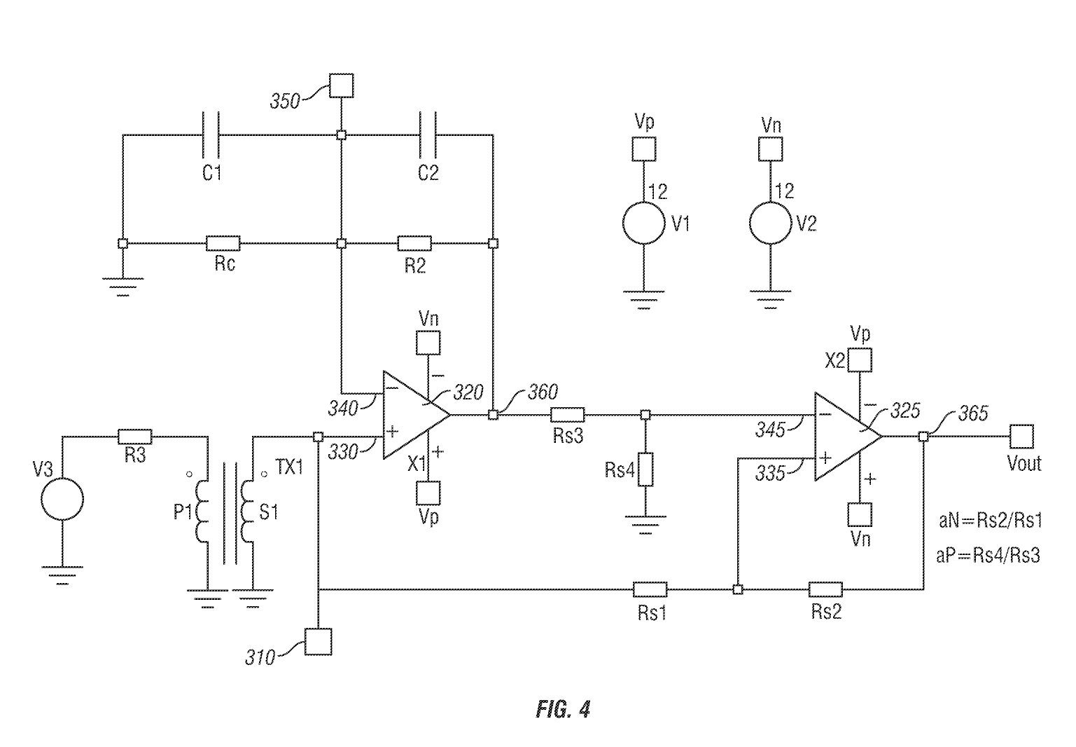

In an alternative embodiment of the disclosure, shown in FIG. 4, an analog summing circuit may be connected at the output 360. One typical summing circuit includes adding resistors RS3, RS4 in a voltage divider configuration with the undivided voltage input connected at the voltage output 360 of differential amplifier 320. The divided voltage may be connected to a noninverting input 335 of differential amplifier 325. The noninverting input 330 may then be connected to another voltage divider formed by resistors RS1, RS2, where the divided voltage is connected to the inverted input 345 of differential amplifier 325 and the output of the voltage divider is connected to the output 365 of differential amplifier 325. In this embodiment, vₒᵤₜ is measured at output 365. As shown, the differential amplifier 325 is pictorially represented by an operational amplifier with a non-inverting input and an inventing input. This representation is illustrative and exemplary only, as embodiments of this disclosure may use any differential amplifier configured to maintain two inputs at an almost identical voltage and with a suitable gain-bandwidth product and gain for the desired application.

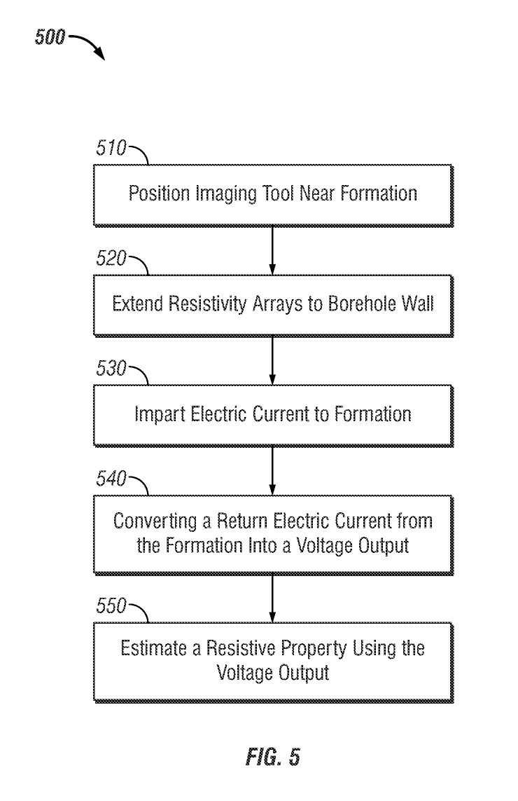

FIG. 5 shows an exemplary method 500 according to one embodiment of the present disclosure. In method 500, an imaging tool 200 is positioned along a wireline within a borehole 126 adjacent to a formation 195 in step 510. Then, in step 520, resistivity arrays 209 are extended to the borehole wall 126. In step 530, imparting an electric current into the formation 195 from at least one center electrode 350. In step 540, converting a returning electric current from the formation into voltage output vₒᵤₜ. And, in step 550, estimating a resistive property using the voltage output of the imaging tool 200. Herein, a resistivity property includes, but is not limited to, at least one of: resistivity, conductivity, impedance, admittance, susceptance, reactance, permittivity, and dielectric constant. In the event that the imaging tool 200 uses multiple center electrodes 350, method 500 may be performed for each individually or as a group.

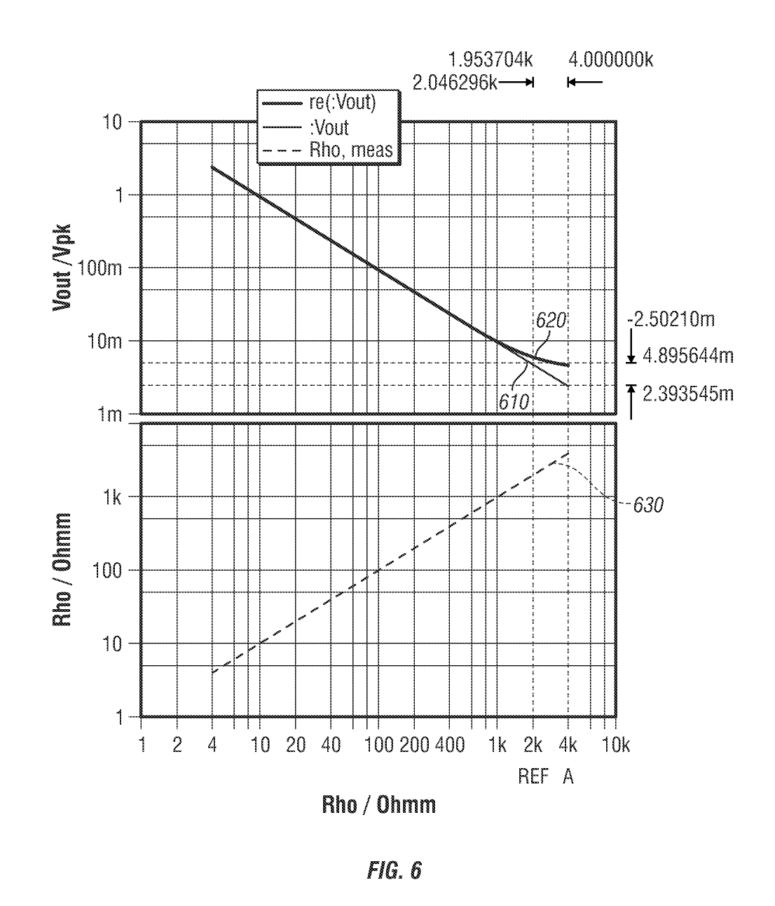

FIG. 6 shows the result of a resistivity sweep from 4 Ωm to 4000 Ωm with an ideal summing circuit featuring infinite common mode rejection for one embodiment according to the present disclosure. The result is an ideal measured resistivity curve (Rho, meas vs. Rho). The upper part of FIG. 6 shows the peak output voltage vs. resistivity, with the real part of Vₒᵤₜ 610 being the required parameter for current and resistivity calculation. The difference between Re{Vₒᵤₜ} 610 and Mag{Vₒᵤₜ} 620 is due to the parasitic capacitance caused by the formation 195 and/or the borehole wall 126 in parallel with the center electrode 350. At 2000 Ωm, a Re{Vₒᵤₜ} value of 4.89 mV is achieved. The apparent resistivity of the formation may be compared with the measured apparent resistivity estimated by the tool 200, as shown in curve 630.

Implicit in the processing of the data is the use of a computer program implemented on a suitable machine readable medium that enables the processor to perform the control and processing. The term processor as used in this application is intended to include such devices as field programmable gate arrays (FPGAs). The machine readable medium may include ROMs, EPROMs, EAROMs, Flash Memories and Optical disks. As noted above, the processing may be done downhole or at the surface, by using one or more processors. In addition, results of the processing, such as an image of a resistivity property, can be stored on a suitable medium.

While the foregoing disclosure is directed to the one mode embodiments of the disclosure, various modifications will be apparent to those skilled in the art. It is intended that all variations be embraced by the foregoing disclosure.

We claim:

1. An apparatus for estimating a resistivity property of an earth formation, comprising:
a downhole assembly configured to be conveyed in a borehole within the earth formation;
a first electrode disposed on the downhole assembly and directly connected to a first input of a first differential amplifier and a voltage source, the first electrode being in contact with a borehole fluid;
a second electrode disposed on the downhole assembly and directly connected to a second input to the first differential amplifier, the second electrode being in contact with the borehole fluid and operatively coupled to the earth formation, the output of the first differential amplifier configured to transmit a signal indicative of the resistivity property.

2. The apparatus of claim 1, further comprising:
a transformer with a primary winding and a secondary winding, the voltage source being connected to the primary winding and the first electrode being connected to the secondary winding.

3. The apparatus of claim 1, further comprising:
a resistor electrically connected between the second input of the first differential amplifier and an output of the first differential amplifier.

4. The apparatus of claim 1, wherein the first input is one of: an inverting input and a non-inverting input, and the second input is different from the first input.

5. The apparatus of claim 1, further comprising:
a summing circuit, the summing circuit connected to the output of the first differential amplifier.

6. The apparatus of claim 5, the summing circuit including a second differential amplifier.

7. The apparatus of claim 1, the second electrode being at least partially surrounded by the first electrode.

8. The apparatus of claim 1, where the fluid is at least one of: (i) water-based drilling fluid and (ii) oil-based drilling fluid.

9. The apparatus of claim 1, wherein the resistivity property comprises at least one of: resistivity, conductivity, impedance, admittance, susceptance, reactance, permittivity, and dielectric constant.

10. A method for estimating a resistive property of an earth formation, comprising:
estimating the resistive property using an apparatus comprising:
a downhole assembly configured to be conveyed in a borehole within the earth formation;
a first electrode disposed on the downhole assembly and directly connected to a first input of a first differential amplifier and a voltage source, the first electrode being in contact with a borehole fluid;
a second electrode disposed on the downhole assembly and directly connected to a second input to the first differential amplifier, the second electrode being in contact with the borehole fluid and operatively connected to the earth formation, the output of the first differential amplifier configured to transmit a signal indicative of the resistivity property.

11. The method of claim 10, further comprising:
positioning a imaging tool in a borehole in the earth formation.

12. The method of claim 10, further comprising using:
a transformer with a primary winding and a secondary winding, the voltage source being connected to the primary winding and the first electrode being connected to the secondary winding.

13. The method of claim 10, further comprising using, for feedback, a resistor electrically connected between the first input of the first differential amplifier and an output of the first differential amplifier.

14. The method of claim 10, further comprising using, for the first input, one of: an inverting input and a non-inverting input, and the second input is different from the first input.

15. The method of claim 10, further comprising using, for performing a difference calculation, a summing circuit, the summing circuit connected to the output of the first differential amplifier.

16. The method of claim 15, further comprising using, for the summing circuit, a second differential amplifier.

17. The method of claim 10, further comprising using, for the first electrode, the first electrode at least partially surrounding the second electrode.

18. The method of claim 10, further comprising using, for the fluid, at least one of: (i) water-based drilling fluid and (ii) oil-based drilling fluid.

19. The method of claim 10, wherein the resistivity property comprises at least one of: resistivity, conductivity, impedance, admittance, susceptance, reactance, permittivity, and dielectric constant.
